(19) United States
(12) Patent Application Publication
(10) Pub. No.: US 2012/0038261 A1
(43) Pub. Date: Feb. 16, 2012

(54) HEAT-DISSIPATING STRUCTURE AND LIGHTING MODULE HAVING THE SAME

(75) Inventors: CHENG-HUNG YU, TAIPEI COUNTY (TW); CHIN-WEI CHOU, TAIPEI COUNTY (TW)

(73) Assignees: KINPO ELECTRONICS, INC., Taipei County (TW); CAL-COMP ELECTRONICS & COMMUNICATIONS COMPANY LIMITED, Taipei County (TW)

(21) Appl. No.: 12/948,939

(22) Filed: Nov. 18, 2010

(30) Foreign Application Priority Data
Aug. 13, 2010 (TW) 99127152

(51) Int. Cl. H01J 61/52; F28D 15/04

(52) U.S. Cl. 313/46; 165/104.26

(57) ABSTRACT

A heat-dissipating structure of lighting includes a main body having a plurality of side surfaces; at least one heat pipe connecting to the main body, wherein each heat pipe has a hot end embedded in the main body and a cold end having a contacting surface; and at least one external heat sink mating to the contacting surface. The instant disclosure also provides a lighting module having said heat-dissipating structure.

### BACKGROUND OF INVENTION

1. Field of the Invention

The present invention relates to a heat-dissipating structure of a lighting module; in particular, a heat-dissipating structure with a main body having external surfaces and heat pipes and a lighting module having the same.

2. Description of the Related Art

As technology advances in favor of more energy-efficient lighting devices, the conventional incandescent light bulbs are gradually being replaced by light-emitting diodes (LEDs).

LEDs possess many advantages over the traditional incandescent light sources including lower energy consumption, longer lifetime, improved robustness, smaller size, faster switching, and greater durability and reliability. Thus, intense research is being conducted in the area of LEDs development. However, like other lighting devices, the performance of LED is temperature dependent. For example, if the junction temperature or the temperature of the semiconducting material is too high due to heat escalation, loss of efficiency would occur. Therefore, proper thermal management of the LED device is required to maintain optimal lighting performance.

To improve heat dissipation capacity, a current technique is to dispose LEDs onto an external heat sink. However, such setup is not adequate enough to dissipate heat effectively.

To address the above issue, the inventor proposes the following solution.

### SUMMARY OF THE INVENTION

The primary object of the present invention is to provide a heat-dissipating structure for lighting modules.

Another object of the present invention is to provide a lighting module having the heat-dissipating structure to maintain the lighting performance.

To achieve the primary object, the instant disclosure provides a heat-dissipating structure having a main body with a plurality of external surfaces; at least one heat pipe connecting to the main body, wherein each heat pipe has a hot end and a cold end, with the hot end being embedded in the main body and the cold end extending to expose from an external surface to define a contacting surface; and at least one external heat sink connecting to the contacting surface.

To achieve the other object, the instant disclosure provides a lighting module having said heat-dissipating structure and at least one light source disposed on the main body.

The instant disclosure presents the following advantages. First, the main body and each heat pipe are formed integrally in one piece. Second, when applied to the lighting module, said heat-dissipating structure can efficiently dissipate heat generated by each light source to prevent overheating.

In order to further appreciate the characteristics and technical contents of the instant disclosure, references are hereunder made to the detailed descriptions and appended drawings in connection with the instant disclosure.

However, the appended drawings are merely shown for exemplary purposes, rather than being used to restrict the scope of the instant disclosure.

### BRIEF DESCRIPTION OF THE DRAWINGS

FIG. 1A is an isometric view of a heat-dissipating structure of lighting for a first embodiment.

FIG. 1B is a schematic view of a heat-dissipating structure of lighting for a first embodiment.

FIG. 2A is an isometric view of a heat-dissipating structure of lighting for a second embodiment.

FIG. 2B is a side view of a heat-dissipating structure of lighting for a second embodiment.

FIG. 2C is a schematic view of a heat-dissipating structure securing to an external heat sink of a second embodiment.

FIG. 2D is a schematic view of an external heat sink.

FIG. 3 is a schematic view of a lighting module.

FIG. 4 is a schematic view of a light source securing to a heat-dissipating structure.

### DETAILED DESCRIPTION OF THE PREFERRED EMBODIMENT

The instant disclosure provides a heat-dissipating structure for lighting to increase the thermal management performance.

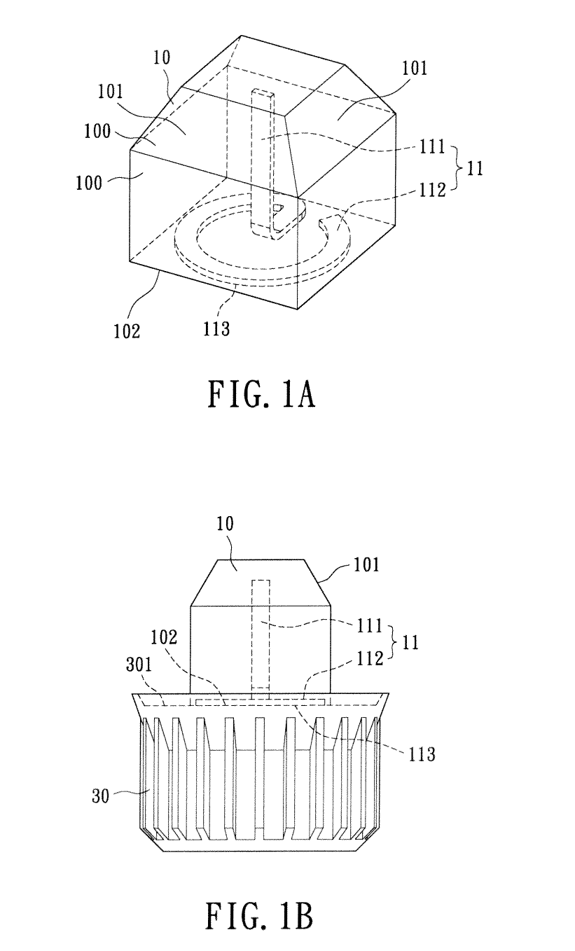

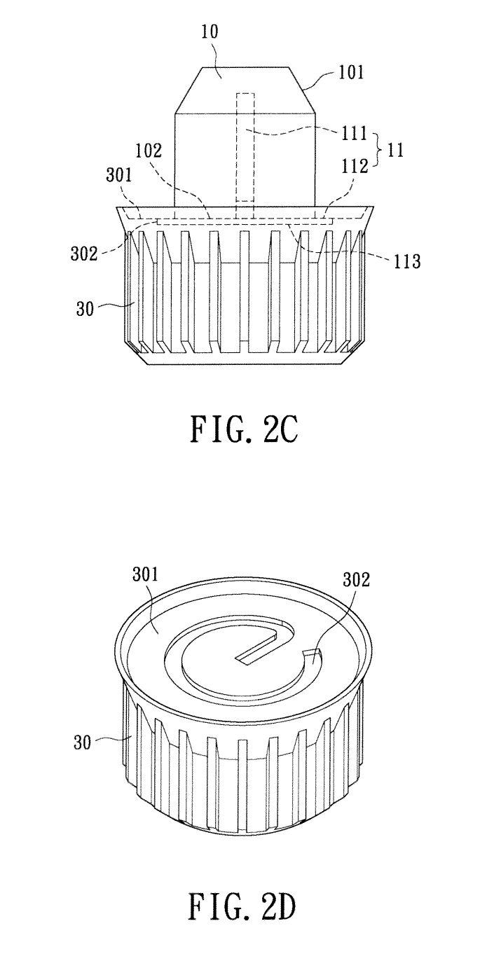

FIG. 1A shows a first embodiment of the instant disclosure. The heat-dissipating structure comprises a main body 10 thermally coupled to a heat pipe 11. The main body 10 has a plurality of external surfaces, such as top surface (not labeled), side surfaces 100 and a bottom surface 102. Specifically, the main body 10 comprises a plurality of polygonal external surfaces to increase external surface area, thereby maximizing the heat dissipating capabilities of the lighting module. Moreover, each side surface 100 may form a fixing area 101, which can have a flat, stepped or curved surface, or any other surface configuration for hosting a light source device, an electronic device, or being used for light reflecting purposes. As shown in FIG. 3, each fixing area 101 can further form a slot 103 to ensure the light source or electronic device, such as a light-emitting diode 20, is firmly mounted. The slot 103 is not restricted in size, shape, and quantity.

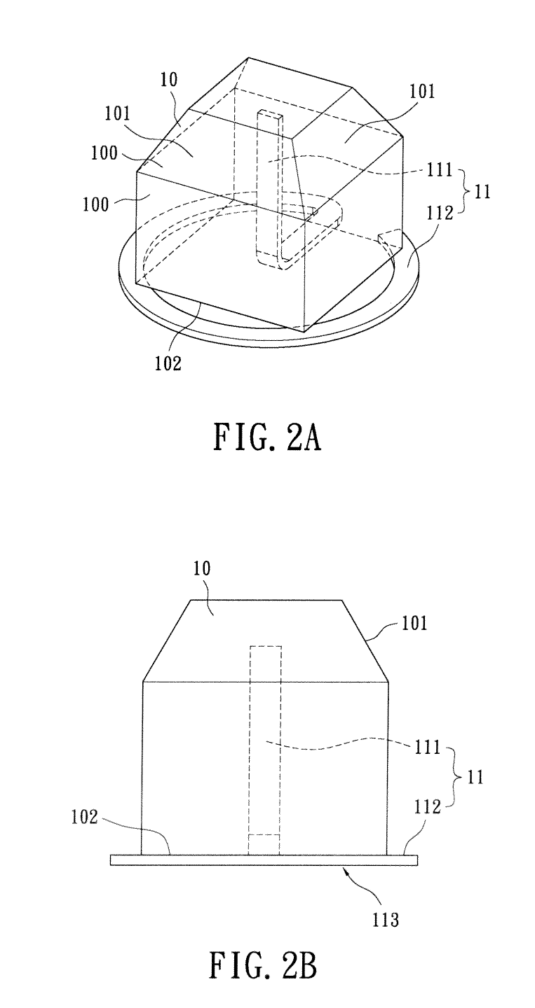

Referring back to FIG. 1A, the heat pipe 11 has a hot end 111 embedded in the main body 10 and a cold end 112 forming a contacting surface 113. To maximize the heat transfer area, the heat pipe 11 has at least one bent surface. For example, the hot end 111 is bended from a vertical position and extended annularly in forming the cold end 112. In the first embodiment, the contacting surface 113 of the cold end 112 is flushed with the bottom surface 102 of the main body 10. Alternatively, as shown in FIGS. 2A and 2B, the cold end 112 can be seated outside of the main body 10.

To provide better heat transfer, the pre-fabricated heat pipe 11 is sintered to the main body 10 in forming a single unit. In other words, the heat pipe 11 is thermally coupled to the main body 10, for example, the heat pipe 11 is physically contact the main body 10. Meanwhile, the main body 10 is made using material of high thermal conductivity, such as aluminum, copper, ceramics, or graphite.

As shown in FIG. 1B, the flushed contacting surface 113 is then secured onto an external heat sink 30. The external heat sink 30 has a receiving surface 301 for mating to the bottom surface 102 and the contacting surface 113. Thus, heat released by the cold end 112 can be dissipated via the external heat sink 30.

On the other hand, where the cold end 112 is seated outside the main body 10, the contacting surface 113 is mated to an external heat sink 30 as follows. A receiving portion 302 is formed on the receiving surface 301 of the external heat sink 30 for connecting with the contacting surface 113. As shown in FIGS. 2C and 2D, the receiving portion 302 can be a groove for mating to the cold end 112. Adhesives or sintering process can be used to connect the receiving portion 302 and contacting surface 113, further to ensure the external heat sink 30 is firmly secured.

Thereby, the heat generated by the light source or electronic device is passed onto the main body 10. The embedded hot end 111 of the heat pipe 11 absorbs the heat from the main body 10 and releases the latent heat at the cold end 112 to the external heat sink 30 for heat dissipation.

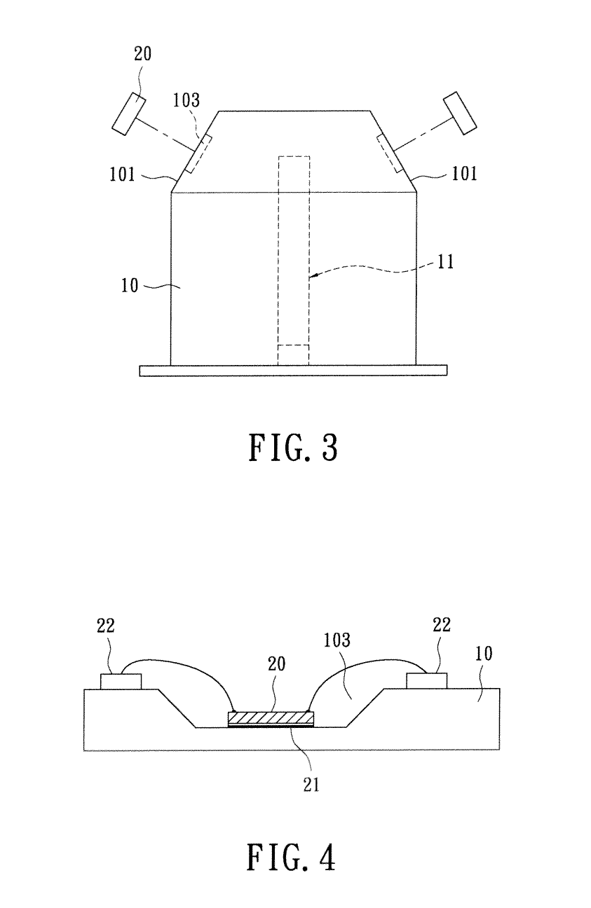

As shown in FIG. 4, the instant disclosure further provides a lighting module having a light source and said heat-dissipating structure. The light source, such as a light-emitting diode 20, is disposed on the main body 10 of the heat-dissipating structure. In particular, an adhesive layer 21 with high thermal conductivity can be used to fix the light-emitting diode 20 onto the slot 103 of the main body 10. The slot 103 is shaped to reflect the light generated by the light source. Electrically connected to conductive blocks 22, the light-emitting diode 20 can be of different types and colors. Furthermore, the lighting module can be placed into a light bulb as a LED lamp.

In summary, the instant disclosure presents the following advantages. First, the heat pipe of the heat-dissipating structure transfers heat more effectively to the external heat sink versus the light source alone. Secondly, the lighting module having said heat-dissipating structure has better thermal management, which allows the lighting module to have longer service life and better lighting quality.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A heat-dissipating structure of lighting, comprising:
a main body having a plurality of external surfaces;
at least one heat pipe thermally coupled to the main body,
wherein each heat pipe has a hot end and a cold end, the hot end is embedded in the main body, the cold end extends to expose from at least one of the external surfaces to form a contacting surface; and
at least one external heat sink connecting to the contacting surface of the heat pipe.

2. The heat-dissipating structure of lighting of claim 1, wherein the cold end extends outside the main body.

3. The heat-dissipating structure of lighting of claim 1, wherein the external heat sink has a receiving portion for connecting to the contacting surface.

4. The heat-dissipating structure of lighting of claim 3, wherein the receiving portion is connected to the contacting surface by sintering process or by adhesives process.

5. The heat-dissipating structure of lighting of claim 1, wherein each heat pipe has at least one bent surface.

6. A lighting module, comprising:
a heat-dissipating structure including
a main body having a plurality of external surfaces,
at least one heat pipe thermally coupled to the main body,
wherein each heat pipe has a hot end and a cold end, the hot end is embedded in the main body, the cold end extends to expose from at least one of the external surface to form a contacting surface,
at least one external heat sink connected to the contacting surface; and
at least one light source disposed on the main body.

7. The lighting module of claim 6, wherein the cold end extends outside the main body.

8. The lighting module of claim 6, wherein the main body has at least one fixing area for accommodating the light source.

9. The lighting module of claim 8, wherein the fixing area has a flat or stepped surface.

10. The lighting module of claim 9, wherein the fixing area further includes a slot to secure the light source.

11. The lighting module of claim 6, wherein the external heat sink has a receiving portion for connecting to the contacting surface.

12. The lighting module of claim 11, wherein the receiving portion is connected to the contacting surface by sintering process or by adhesives process.

13. The lighting module of claim 6, wherein each heat pipe has at least one bent surface.
